(19) United States
(12) Patent Application Publication
(10) Pub. No.: US 2013/0231965 A1
(43) Pub. Date: Sep. 5, 2013

(54) TRANSPORT BOOKING MANAGEMENT

(71) Applicant: Oren TOKATLY, Mevaseret Zion (IL)

(72) Inventor: Oren TOKATLY, Mevaseret Zion (IL)

(21) Appl. No.: 13/785,891

(22) Filed: Mar. 5, 2013

Related U.S. Application Data
(60) Provisional application No. 61/606,519, filed on Mar. 5, 2012.

(51) Int. Cl. G06Q 10/02

(52) U.S. Cl. CPC G06Q 10/02
USPC 705/5

(57) ABSTRACT

The subject matter disclosed herein includes a system and method of ticket booking management of a passenger transport vehicle that enables online tickets purchasing regardless of the passenger's location or time of ordering the tickets, or the station they wish to board the vehicle, including intermediate stations. The passenger transport vehicle comprises a plurality of places for accommodating passengers; the places can comprise at a given time a combination of booked seats, which are previously booked by respective passengers, and non-booked seats, which are available for passengers who board the vehicle, in the traditional way, without a previously booked seat.

This application claims priority of U.S. Provisional Application No. 61/606,519 dated 5 Mar. 2012.

### FIELD OF THE PRESENTLY DISCLOSED SUBJECT MATTER

The present disclosure relates to the field of passenger transport in general, and more particularly but not exclusively to passenger transport booking systems.

### BACKGROUND

Passenger transport is a shared passenger transportation service which is available for use by the general public, as distinct from modes such as taxicab, car pooling or hired buses which are not shared by strangers without private arrangement. Public transport modes include buses, trams and trains, rapid transit (metro/subways/undergrounds etc.) and scheduled ferries.

Public transport runs according to a scheduled timetable of fixed routes. Some services wait until the vehicle is fully occupied before exiting the station. Urban public transport may be provided by one or more private transport operators or by a transit authority. Public transport services are usually funded by government subsidies and fares charged to each passenger. Services are normally regulated and possibly subsidized from local or national tax revenue. Such regulations may include for example limitations on the number of passengers allowed to travel in a transport vehicle and on the number of passengers allowed to stand in the transport vehicle.

Usually public transport operates on a non-reservation basis, but there are systems and methods for early purchasing tickets or even reserving tickets for passenger transport. Some systems provide information about planned schedules, and the members of the public are able to buy tickets in advance, while others enable also reserving specific seats. Such systems enable offline reservation, provided that the seat is available at the time of reservation.

The Swiss travel and transport company SBB enables to purchase tickets from its website as well as from a Smartphone. The user can reserve a ticket from any starting point to any destination. The system also provides to the user a general indication about the expected occupancy level on the train. USA application 2007078691 describes an information processing apparatus for producing vacant seat forecast information, including a planned station name and where to alight.

### GENERAL DESCRIPTION

The term passenger transport vehicle refers herein to any vehicle that is used for transporting a plurality of passengers from one place to the other, on scheduled service and fixed routes. Passenger transport vehicles include, but are not limited to, buses, trains, subways, ferries, (including a specific car in a train or bus comprising multiple cars) and the like. By way of non-limiting example only, the description herein occasionally refers to bus based transportation, and it is appreciated that the same principles can be applied to any other passenger transport vehicles mutatis mutandis.

The term online booking refers herein to booking a place on a passenger transport vehicle while the passenger transport vehicle is already on its way on a scheduled route. During this time, passengers, who do not have a reserved place, may board or leave the transport vehicle.

The term offline booking refers herein to booking a place on a passenger transport vehicle before the passenger transport vehicle is on its way; for example, a day prior to the scheduled time.

The term occupancy refers herein to the availability of free seats and/or to the availability of standing places on a passenger transport vehicle.

The term electronic ticket refers herein to any ticket in digital format. An electronic ticket may be provided for example, by an email message, by a web page, by an SMS message, by a mobile Smartphone message or by a dedicated terminal. An electronic ticket may also include a QR code or some other identifying information.

According to some embodiments there is provided a system and a method for online transportation booking. In some embodiments the system enables a passenger to purchase a ticket while waiting at any stop of the route (for example at a bus stop). In some embodiments the system enables a passenger to purchase a ticket in close proximity to the time that he/she is scheduled to arrive at the bus stop. In some cases the passenger books the tickets while the passenger transport vehicle is already on its way. In some other cases a passenger books tickets before departure time. In some other embodiments, the system enables offline booking. Booking can be facilitated by a computerized device. The computerized device may be a Smartphone, a personal computer, a laptop, a terminal located at a station and the like. In some embodiments booking includes booking a seat as well as booking a standing place.

In some cases, the system enables users who are waiting at any bus stop (including intermediate bus stops) to reserve tickets. In some embodiments the system enables users to reserve tickets while still enabling other users to purchase tickets while getting on the bus.

In some embodiments, the system provides statistical information about the real-time demand for a specific passenger transport vehicle (for example for a specific bus line) at a certain time and also retroactively for a certain date. Such information enables the operator of the passenger transport to adjust the schedule of the passenger transport according to real-time demand. For example, a bus operator may add more buses in a specific line at a specific time as a result of identifying unexpected increased demand.

Such a system provides a solution both for the passengers as well as for operators.

In some cases the system provides an electronic ticket. In some cases the system includes a positioning system application (e.g. GPS application) that provides passengers with information regarding the current location of a specific passenger transport vehicle and regarding the expected arrival time. The system can serve registered users or an occasional passenger. In some embodiments the system provides statistical data which enables to improve the efficiency of passenger transport.

Aspects of the presently disclosed subject matter include:

According to one aspect of the presently disclosed subject matter there is provided a system of ticket booking management of a passenger transport vehicle, the passenger transport vehicle comprising a plurality of places for accommodating passengers; the places can comprise at a given time a combination of booked places, which are previously booked by respective passengers and non-booked places, which are available for passengers who board the vehicle without a previously booked place; the system further comprises a vehicle management extension of a respective passenger transport vehicle, comprising at least one processer operatively connected to a computer memory and configured to obtain information with respect to a request of a respective passenger, to book a place on the vehicle; obtain a first occupancy data indicative of currently occupied places on the vehicle; obtain a second occupancy data indicative of currently booked places on the vehicle; determine, based on the first occupancy data and the second occupancy data whether a vacant place is available for the respective passenger; and book a place on the vehicle for the respective passenger in case it is determined that a vacant place is available.

According to certain embodiments of the presently disclosed subject matter, the vehicle management extension further comprises a data-repository for storing at least the first and second occupancy data; the processor is further configured to continuously obtain information with respect to the first occupancy data and the second occupancy data and update the first and second occupancy data stored in the data-repository accordingly.

According to certain embodiments of the presently disclosed subject matter, the vehicle management extension is operatively connected to one or more sensors located in the vehicle and configured to obtain the first occupancy data.

According to certain embodiments of the presently disclosed subject matter, the vehicle management extension comprises a communication facility configured to enable communication with one or more client devices and obtain from the one or more client devices one or more requests to book places.

According to certain embodiments of the presently disclosed subject matter, the vehicle management extension comprises a communication facility configured to enable communication with one or more client devices and obtain from the one or more client devices one or more requests to book places.

According to certain embodiments of the presently disclosed subject matter, the request includes information indicating a respective destination; the processor is further configured, responsive to information indicative that a seat has become empty, to determine whether the respective passenger has reached a respective destination and in case the passenger has done so, to assign the seat as vacant and update the first and second occupancy data accordingly.

According to certain embodiments of the presently disclosed subject matter, the system comprises an indicator for each seat, indicating whether the seat is occupied.

According to certain embodiments of the presently disclosed subject matter, the system further comprises a driver's command and control configured to provide the driver with information with respect to the first occupancy data and the second occupancy data, enabling the driver to determine whether or not to allow boarding of one or more passengers on the vehicle.

According to certain embodiments of the presently disclosed subject matter, the passenger transport vehicle is a bus.

According to another aspect of the presently disclosed subject matter there is provided a computerized method of ticket booking management of a passenger transport vehicle, the passenger transport vehicle comprising a plurality of places for accommodating passengers; the places can comprise at a given time a combination of booked places, which are previously booked by respective passengers, and non-booked places, which are available for passengers who board the vehicle without a previously booked place; the method comprises:

obtaining information with respect to a request, of a respective passenger, to book a place on the vehicle; obtaining a first occupancy data indicative of currently occupied places on the vehicle; obtaining a second occupancy data indicative of currently reserved places on the vehicle; determining, based on the first occupancy data and the second occupancy data whether a vacant place is available for the respective passenger; and booking a place on the vehicle for the respective passenger in case it is determined that a vacant place is available.

According to certain embodiments of the presently disclosed subject matter, the method further comprises obtaining information with respect to the first occupancy data and the second occupancy data and updating the first and second occupancy data stored in a designated data-repository.

According to certain embodiments of the presently disclosed subject matter, the method further comprises obtaining, from one or more sensors located in the vehicle, the first occupancy data.

According to certain embodiments of the presently disclosed subject matter, the method further comprises enabling communication with one or more client devices and obtaining from the one or more client devices one or more requests to book places.

According to certain embodiments of the presently disclosed subject matter, the method further comprises obtaining, from a client device, information with respect to the request, information indicative of a selected route, time and date, identifying a corresponding vehicle which matches the information in the request, and sending the request to the corresponding vehicle.

According to certain embodiments of the presently disclosed subject matter, the method further comprises obtaining information with respect to real-time demands for one or more vehicles and respective routes; and adapting the allocation and scheduling of vehicles to the real-time demand.

According to certain embodiments of the presently disclosed subject matter, the method further comprises obtaining, from an indicator in each seat, data indicative as to whether the seat is booked by a respective passenger.

According to certain embodiments of the presently disclosed subject matter, the method further comprises providing, to a driver of the vehicle, information with respect to the first occupancy data and the second occupancy data, enabling the driver to determine whether or not to allow boarding of one or more passengers on the vehicle.

According to yet another aspect of the presently disclosed subject matter there is provided a program storage device readable by machine, tangibly embodying a program of instructions executable by the machine to perform a method of ticket booking management of a passenger transport vehicle, the passenger transport vehicle comprising a plurality of places for accommodating passengers, the places can comprise at a given time a combination of booked places, which are previously booked by respective passengers, and non-booked places, which are available for passengers who board the vehicle without a previously booked place; the method comprises obtaining information with respect to a request, of a respective passenger, to book a place on the vehicle; obtaining a first occupancy data indicative of currently occupied places on the vehicle; obtaining a second occupancy data indicative of currently reserved places on the vehicle; determining, based on the first occupancy data and the second occupancy data, whether a vacant place is available for the respective passenger; and booking a place on the vehicle for the respective passenger in case it is determined that a vacant place is available.

The program storage device can comprise, mutatis mutandis, one or more of the above features listed above with respect to the system and method.

Additionally or alternatively to the above features, the system, method and program storage device disclosed herein, can optionally comprise one or more of features (i) to (xv) below, mutatis mutandis, in any desired combination or permutation.

According to certain embodiments of the presently disclosed subject matter, the request includes information indicating a respective destination; the processor is further configured, responsive to information indicative that a seat has become empty, to determine whether the respective passenger has reached a respective destination and in case the passenger has done so, to assign the seat as vacant and update the first and second occupancy data accordingly.

According to certain embodiments of the presently disclosed subject matter, the places include seats and standing places in the vehicle, wherein the vacant place is a vacant seat and in case no vacant seat is available, the processor is further configured to send to a client device of the respective passenger a selection between a standing place in the next vehicle and a seat in a different vehicle.

According to certain embodiments of the presently disclosed subject matter, the request to book a place on the vehicle is an online booking, received while the vehicle is on its way on its scheduled route.

According to certain embodiments of the presently disclosed subject matter, the request to book a place on the vehicle is an offline booking, received before the vehicle is on its way on its scheduled route.

According to certain embodiments of the presently disclosed subject matter, the request includes information indicative of a selected route, the rout comprising multiple stations; the information being further indicative of a boarding station, where the passenger is destined to board the vehicle and a disembark station, where the passenger is destined to leave the vehicle; wherein the boarding station and the disembark station may be any one of the multiple stations.

According to certain embodiments of the presently disclosed subject matter, only part of the plurality of places on the vehicle is designated for booking and the other part is designated for passengers boarding the vehicle without booking.

According to certain embodiments of the presently disclosed subject matter, the system is further operable to provide to a client device of the respective passenger, information indicating the current location of the vehicle.

According to certain embodiments of the presently disclosed subject matter, the system is further operable to provide to a client device of the respective passenger, an electronic ticket.

Additionally or alternatively to the above, the method, the device, the computer program product, the computer storage device and the system, disclosed in accordance with the presently disclosed subject matter can optionally comprise one or more of features listed above, mutatis mutandis, in any desired combination or permutation.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 shows a block diagram of an exemplary online transportation booking system, in accordance with the presently disclosed subject matter;

FIG. 2 shows an exemplary flowchart diagram of operations of online transportation booking, in accordance with the presently disclosed subject matter;

FIG. 3 shows an exemplary flowchart diagram of operations performed by a central management system for online transportation booking, in accordance with the presently disclosed subject matter;

FIG. 4 shows an exemplary flowchart diagram of operations performed by a vehicle management extension for online transportation booking, in accordance with the presently disclosed subject matter;

FIG. 4a shows an exemplary flowchart diagram of operations for processing a request for ordering a ticket, in accordance with some exemplary embodiments of the disclosed subject matter;

FIG. 4b shows an exemplary flowchart diagram of a method for processing a request when a seat becomes empty, in accordance with the presently disclosed subject matter;

FIG. 5 shows a functional block diagram of a system that is installed on a passenger transport vehicle, in accordance with the presently disclosed subject matter;

FIG. 6 shows an exemplary driver command and control screen, in accordance with the presently disclosed subject matter; and

FIG. 7 shows a functional block diagram illustrating a central management system, in accordance with the presently disclosed subject matter.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

The disclosed subject matter is described below with reference to flowchart illustrating functions/operations and block diagrams illustrating apparatus (systems) according to embodiments of the subject matter. It will be understood that the presently disclosed subject matter further contemplates computer program instructions for implementing part or all of the described operations. These computer program instructions may be provided to a processor of a general purpose computer, special purpose computer, or other programmable data processing apparatus to produce a machine configured to implement the functions/operations described with reference to the figures disclosed herein.

These computer program instructions may also be stored in a computer-readable medium that can direct a computer or other programmable data processing apparatus to function in a particular manner, such that the instructions stored in the computer-readable medium produce an article of manufacture including instructions for implementing the functions/operations described with reference to the figures disclosed herein.

The computer program instructions may also be loaded onto a computer or other programmable data processing apparatus to cause a series of operations to be performed on the computer or other programmable apparatus to produce a computer implemented process such that the instructions loaded onto the computer or other programmable data processing apparatus provide processes for implementing the functions/operations described with reference to the figures disclosed herein.

The flowchart and block diagrams in the Figures illustrate the architecture, functionality, and operation of possible implementations of systems, methods and computer program products according to various embodiments of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, operations, elements, and/or components, but do not preclude the presence or addition of one or more other features, integers, operations, elements, components, and/or groups thereof.

It is note that unless indicated otherwise the term “exemplary” is used herein to describe an illustration of a non-limiting example.

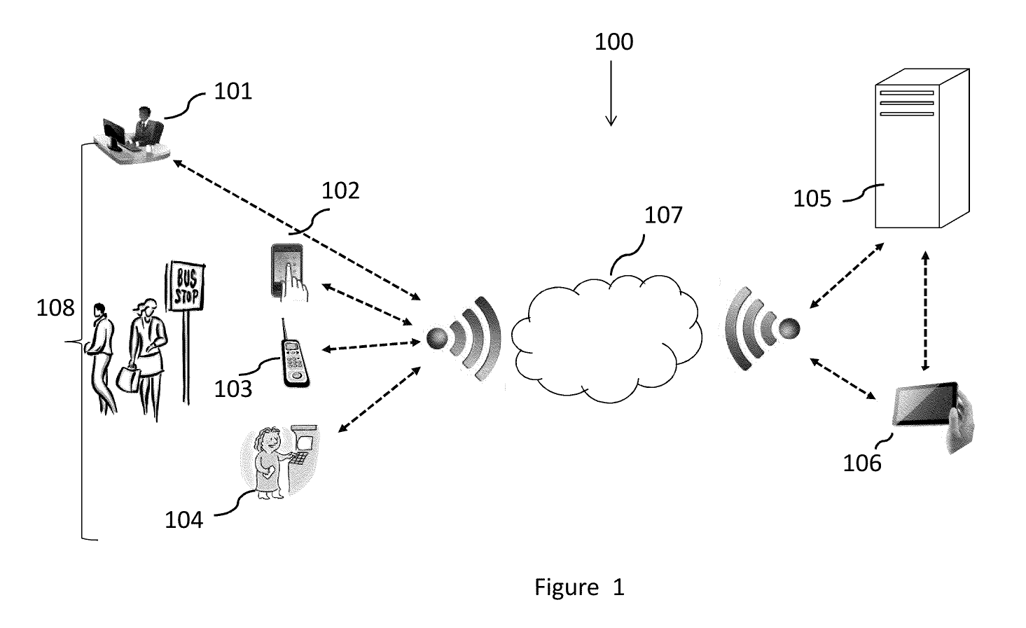

Each one of central management system 105, vehicle management extension 106 and devices 108 illustrated in FIG. 1 comprise, or is otherwise associated with a non-transitory computer memory and one or more processors configured to execute operation as disclosed herein. The term processor as used herein should be expansively construed to cover any kind of electronic device with data processing capabilities, including, by way of non-limiting example, a personal computer, a server, a computing system, a communication device, a processor (e.g. digital signal processor (DSP), a microcontroller, a field programmable gate array (FPGA), an application specific integrated circuit (ASIC), etc.), any other electronic computing device, and or any combination thereof.

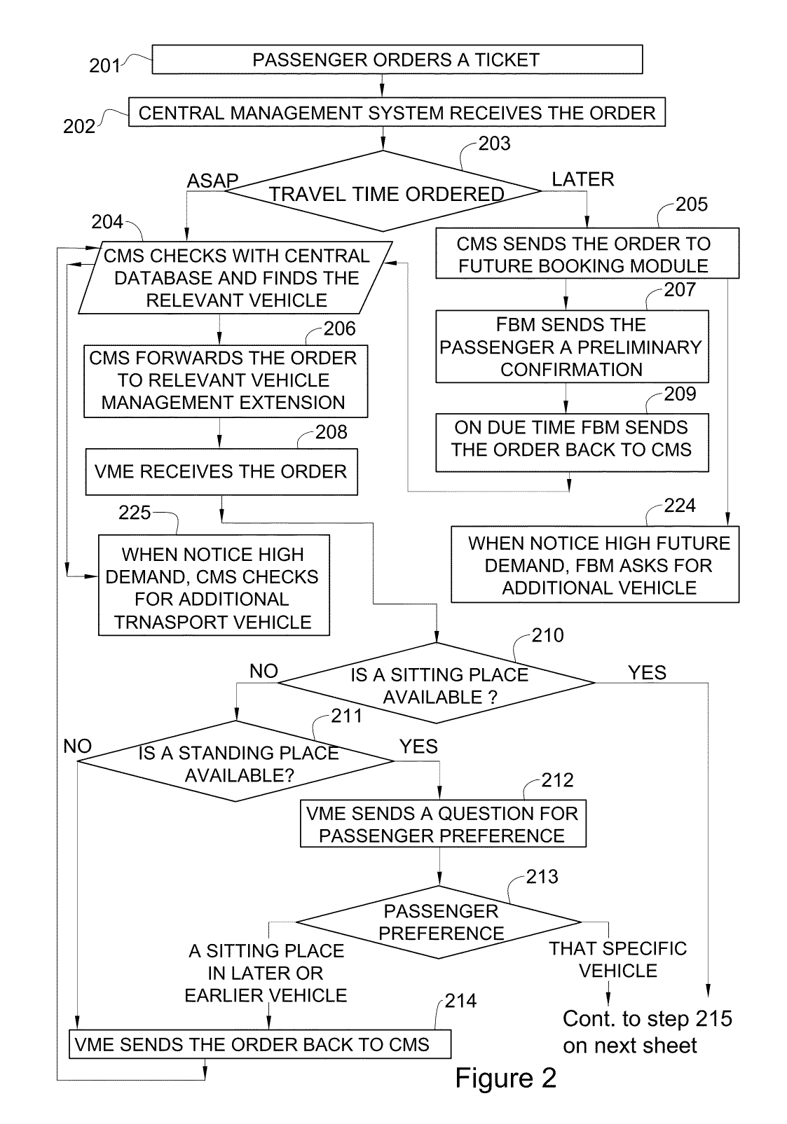

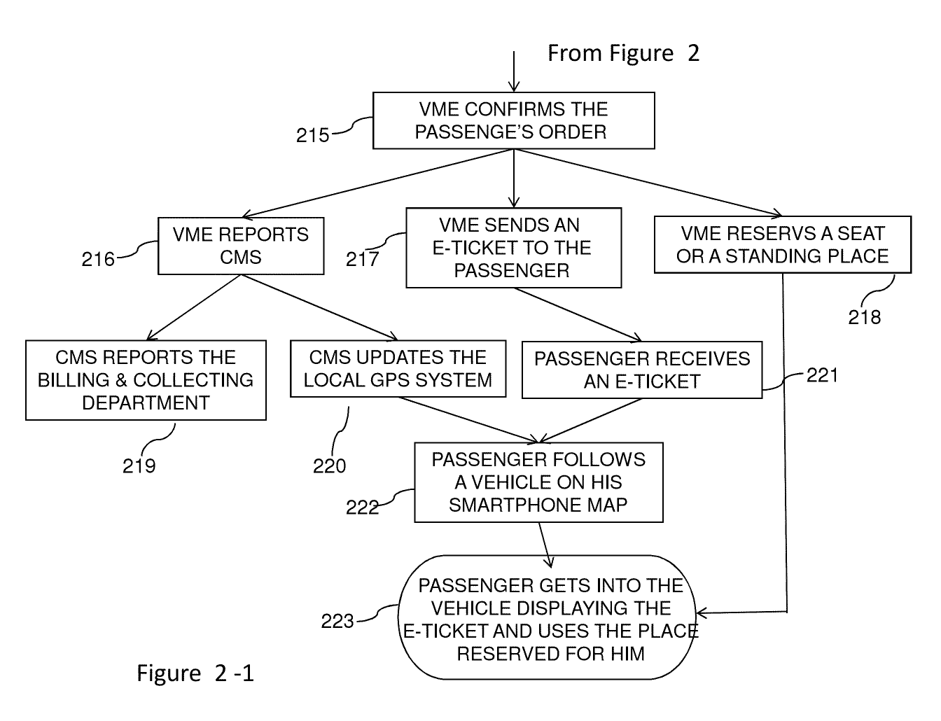

In embodiments of the presently disclosed subject matter, fewer, more and/or different stages than those shown in FIGS. 2-4 may be executed. In embodiments of the presently disclosed subject matter one or more stages illustrated in FIGS. 2-4 may be executed in a different order and/or one or more groups of stages may be executed simultaneously. FIGS. 1, 5, 6 and 7 illustrate a general schematic of function block diagrams of the system components in accordance with an embodiment of the presently disclosed subject matter. The different module/entities in FIGS. 1, 5, 6 and 7 may be centralized in one location or dispersed over more than one location. In other embodiments of the presently disclosed subject matter, the system may comprise fewer, more, and/or different modules/entities than those shown in FIGS. 1, 5, 6 and 7.

One technical problem dealt with by the present disclosure is to provide data related to occupancy of a public transport vehicle, wherein passengers using the passenger transport vehicle may join or leave the ride at any time and at any place. A technical problem may arise, for example, when a passenger wishes to ensure a seat on a bus while waiting for the bus or before going to the bus stop. Such a technical problem may also arise in a controlling system that schedules the ride of passenger transport vehicle according to occupancy.

One technical solution, provided herein, is a system and methods that enable online booking by monitoring and controlling occupancy of any passenger transport vehicle that is used by the system.

Passenger transport vehicles are scheduled to serve passengers while meeting efficiency and keeping within the budget of the provider. As a result, a passenger may wait a long time at the bus stop since the scheduled bus is occupied and cannot serve the passenger. A system that provides the online booking of a seat and/or a standing place on a passenger transport enables a passenger to ensure a place or even a seat. Such a system also enables the provider to control passenger transport according to passenger real-time demand. For example, when there are a lot of passengers waiting for a bus, another bus can be added. A more efficient passenger transport encourages the usage of passenger transport and reduces usage of private vehicles, thus contributing to conservation of the environment.

Referring now to FIG. 1 showing a block diagram of an exemplary online transportation booking system, in accordance with some exemplary embodiments of the subject matter. System 100 comprises central management system (CMS) 105, vehicle management extension (VME) 106, and computerized (client) devices 108 illustrated here as a personal computer 101, Smartphone 102, mobile phone 103 and a dedicated terminal 104.

The central management system 105 is configured to receive booking orders from a plurality of passengers and to transfer each booking order to the relevant vehicle management extension 106. In some embodiments, the central management system 105 receives responses from the vehicle management extension and forwards the responses to the computerized devices 108 of the passengers. In some other embodiments the vehicle management extension communicates directly with the computerized devices 108 of the passengers without the mediation of the central management system 105.

In some embodiments, the central management system 105 controls the transportation by issuing a request to operate one or more additional transport vehicles as a result of a notification from the vehicle management extension 106 about a fully loaded bus. In some embodiments the central management system 105 also sends an electronic ticket to the passenger. In other embodiments, such an electronic ticket is sent directly by the vehicle management extension 106.

In some embodiments the central management system 105 generates reports on the passengers' orders and on the occupancy of the passenger transport vehicle.

The central management system 105 can communicate with the computerized devices 108 and with the vehicle management extension 106 via the Internet cloud 107.

A computerized device 108 is configured to enable booking a place in the bus. The computerized device 108 enables to send a request message to the central management system 105. The request is forwarded to the vehicle management extension 106 of the relevant bus and may be processed there. A response is forwarded from the vehicle management extension 106 to the computerized device 108. In some cases the response is forwarded through the central management system 105. The computerized devices 108 can be configured to display the response of the vehicle management extension 106 on a display of the computerized devices 108. In some cases the computerized device 108 can be configured to produce an electronic ticket to the passenger. In some other cases, the computerized device can be configured to receive the electronic ticket from the central management system 106.

In some embodiments device 108 can comprise a navigation tool (e.g. GPS based) which shows the current location and the route of the passenger transport vehicle for which the reservation was made, and also its estimated arrival time.

The vehicle management extension 106 is a computerized device (such as a tablet, a laptop computer, a personal computer, etc) located in the passenger transport vehicle. The vehicle management extension 106 receives a booking request from the central management system 105 and analyses the request. The vehicle management extension 106 generates a response to the request.

FIG. 2 shows an exemplary flowchart diagram of operations of transportation booking, in accordance with the presently disclosed subject matter.

At 201, a passenger orders a ticket (e.g. bus ride ticket). The ticket can be ordered from computerized device 108 which can be for example, a Smartphone, a personal computer, a laptop, a dedicated terminal located at a bus-stop or at some other publicly available location, or from any other computerized device.

At 202, the order is received at central management system (CMS 105). The order can be received, for example, by booking management module 1703 configured in general for managing booking of tickets.

The central management system checks (e.g. with the help of booking management module 1703) the details of the order request, which can include the requested route and travel time of the order (block 203).

Operations described with reference to blocks 205, 207 and 209 are performed if the travel time is not immediate.

Optionally, the order is sent (e.g. from booking management module 1703) to future booking module 1704 (block 205).

At 207, future booking module 1704 can be configured to send a preliminary confirmation to the passenger. Future booking module can be further configured to store the order in a designated data-repository (1702).

At 209, when time of the order is due, future booking module 1704 can be configured to send the order back to the central management system (e.g. to booking management unit 1703). The operation proceeds to block 204.

Operations described with reference to blocks 204, 206, and 208 are performed either if the original travel time ordered is immediate, or when receiving the order from the future booking department.

At 204, the central management system checks (e.g. with the help of booking management module 1703) in database 1702 and finds the relevant bus, e.g. the first bus, arriving closest to the requested time, in the specific relevant line (route).

At 206, the central management system forwards the order to the relevant vehicle management extension. At 208, the vehicle management extension receives the order.

At 210, it is determined (by the respective vehicle management extension on the relevant bus) whether there is a vacant seat on the respective bus which can be ordered. This operation can be performed by vehicle management extension 106 on the respective bus which can be configured to obtain this information mechanically or electronically. Alternatively or additionally this information can be obtained by a human (e.g. the bus driver). This is based on a first occupancy data indicative of currently occupied places on the vehicle and a second occupancy data indicative of reserved places (places which were previously ordered by passengers) on the vehicle, some of which may be currently unoccupied. Based on the first and second occupancy data vehicle management extension 106 can determine whether there are vacant places on the bus.

Optionally in case no seat is available on the respective bus, it is determined whether a standing place is available (block 211). For example, it is determined whether the number of passengers who are currently standing together with the number of passenger that already ordered standing places, are less than the maximal allowed number of standing passengers.

Optionally, if it is determined that a standing place is available, vehicle management extension 106 can be configured to send a query to device 108 regarding the passenger preference—i.e. whether the passenger prefers a standing place in that specific vehicle, or a sitting place in another bus arriving at a different time (e.g. a later bus, or an earlier bus, if there is such a possibility) (block 212). The request can be displayed on the display of the passenger's computerized device 108.

At 213, the passenger preference is received and checked by the vehicle management extension 106.

If the preference of the passenger is to wait for a sitting place then, at 214 vehicle management extension 106 can be configured to send the order back to central management system 105. The operation resumes to block 204.

If the preference of the passenger is for a standing place on a specific bus (e.g. the next bus) then, at 215, vehicle management extension 106 confirms the order.

At 216, vehicle management extension 106 sends a confirmation to central management system 105.

At 217, vehicle management extension 106 sends an electronic ticket to the passenger.

At 221, the passenger receives an electronic ticket (e.g. at the passenger's device 108).

At 218, vehicle management extension 106 reserves a seat or a standing place.

At 219, central management system 105 sends a report to the billing and collecting department. Alternatively billing of clients can be performed automatically by billing module 1706 configured for automatically processing the billing.

At 221 the passenger receives the electronic ticket.

Optionally, central management system 105 (or vehicle management extension 106) is configured to update a positioning system, which can be based for example on a GPS system or cellular localization system (block 220). The passenger's device (108) is provided with information indicative of the current location of the respective bus and this information can be displayed on a display of device 108. The passenger can follow the current location of the bus in which a place is reserved for him on a map displayed on device 108 (e.g. on his Smartphone) (block 222).

At 223, the passenger gets onto the bus, on which a place is reserved for him. For example, the passenger can display the electronic-ticket to an electronic reader or the driver, and use the place reserved for him.

If central management system 105 determines (e.g. with the help of booking management module 1701) that high future demand exists for a given bus, central management system can be configured to notify future booking module 1704 to issue one or more additional buses (block 224).

If central management system 105 determines, based on the incoming orders of tickets (e.g. with the help of booking management module 1701) that there is current high demand for a given bus, central management system can be configured to check for an immediate additional bus (block 225).

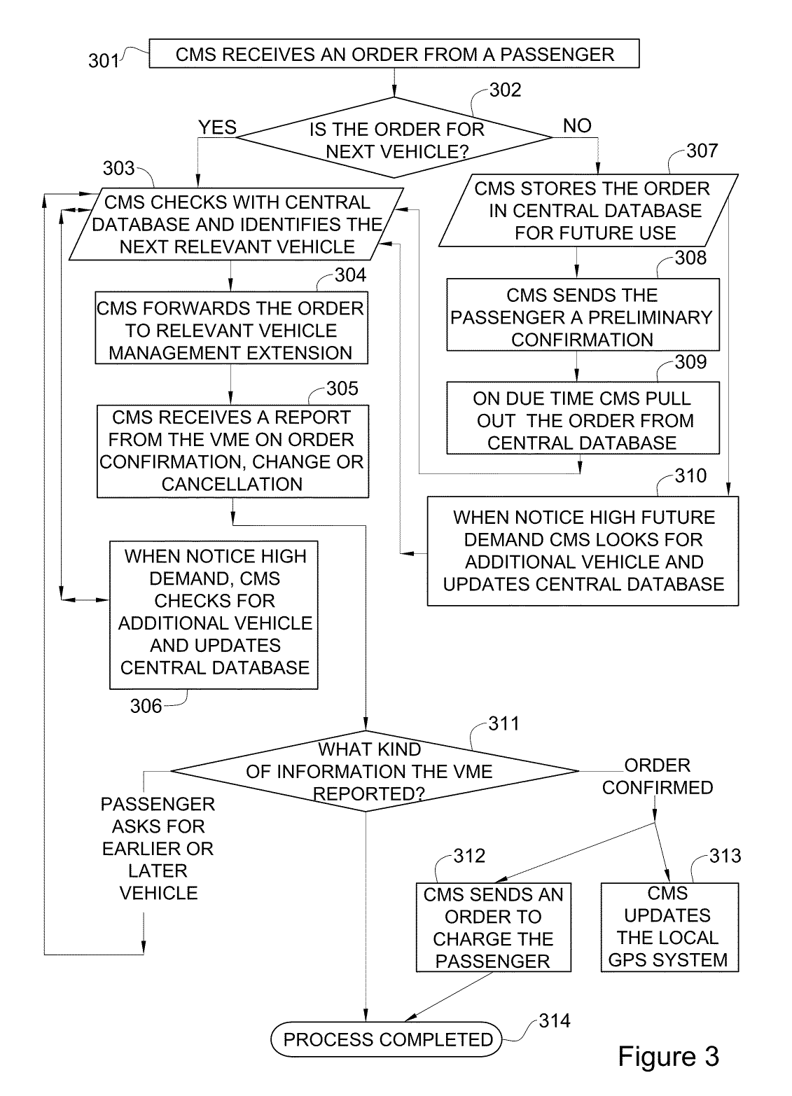

FIG. 3 shows an exemplary flowchart diagram of operations performed by central management system for online transportation booking, in accordance with some exemplary embodiments of the disclosed subject matter.

At 301, a booking order is received from a passenger (e.g. at booking management module 1701) and it is determined whether the order is for the next bus (block 302). The term “next bus” refers to the next scheduled passenger transport vehicle.

Operations described with reference to blocks 303, 304, 305 and 306 are performed if the order is for the next bus.

At 303, the next relevant bus is identified. Identification is carried out, for example, by searching in a data repository for the bus of the requested bus line that has departed from its base station and is on its way, has not yet arrived to the bus stop (indicated as a boarding bus stop by the passenger) and is currently the closest bus to the boarding bus stop of the passenger who issued the request.

At 304, the order is forwarded to vehicle management extension of the next bus.

Optionally, central management system 105 can receive information from vehicle management extension with respect to order confirmation, change in order or cancellation (block 305).

At 306, central management system 105 can be configured to notice a high demand for a certain bus, check for an additional bus and update the central database. If high demand for a given bus route is identified, central management system can be configured to allocate additional buses to that bus route.

Operations described with reference to blocks 307, 308, 309 and 310 are performed if the order is for the scheduled bus.

At 307, central management system 105 stores the order in the central database for future use.

At 308, central management system 105 sends a preliminary confirmation to the passenger.

At 309, which occurs on due time, the central management system extracts the order from the database.

If a high future demand is noticed, the system proceeds to 310. The central management system looks for an additional bus and updates the database accordingly. The operation then resumes to block 303.

At 311, the central management system checks the report from the respective vehicle management extension. If the report indicates an earlier or later bus, the operation resumes to 303.

Operations described with reference to blocks 312 and 313 occur if the report includes a confirmation.

At 312, central management system 105 sends instructions to charge the passenger.

At 313, central management system 105 updates the local GPS system.

The process is completed at 314, both after blocks 312 and 313, on order confirmation, and also in cases where the order was cancelled by the passenger.

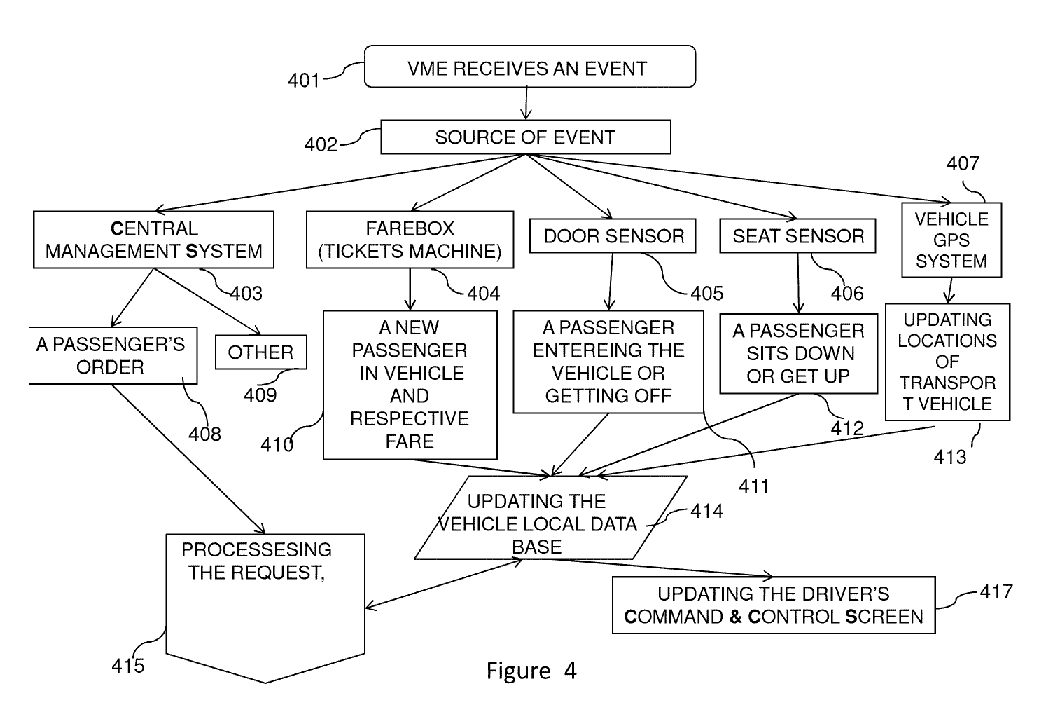

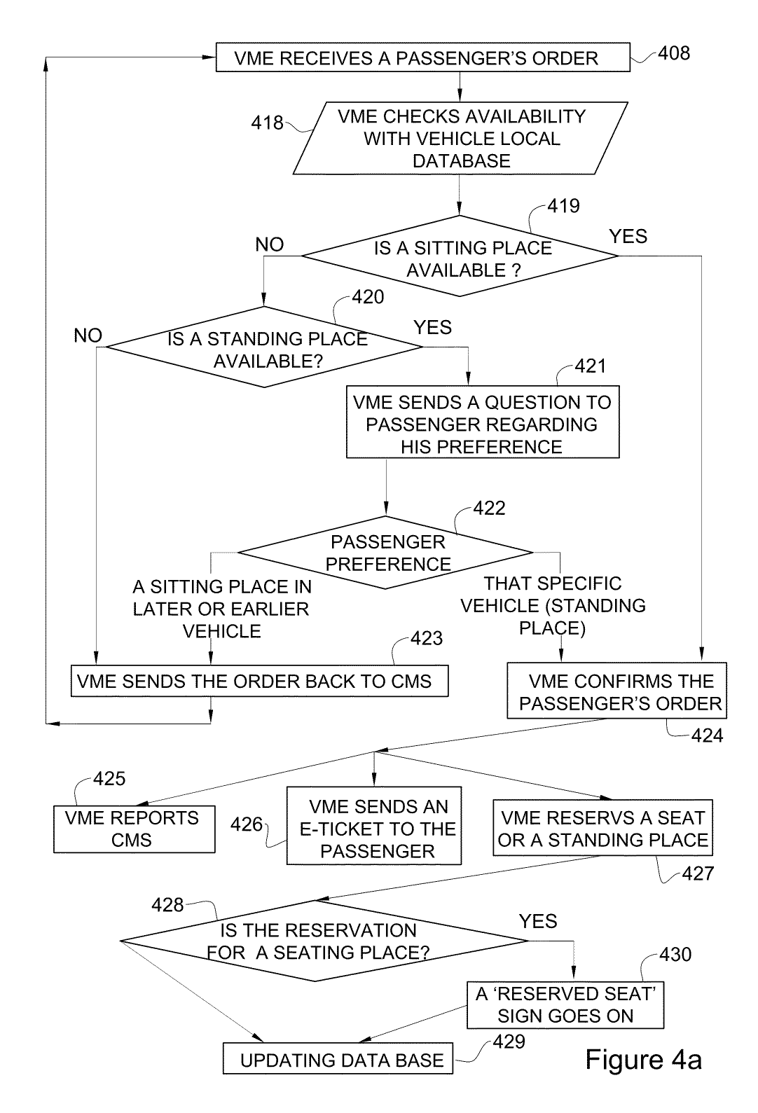

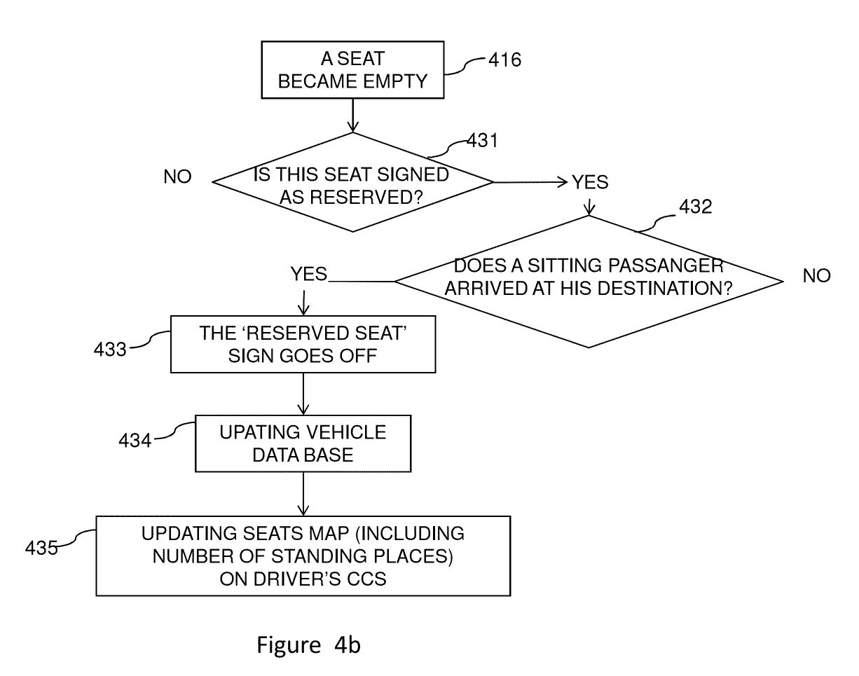

FIG. 4 shows an exemplary flowchart of operations performed by vehicle management extension for transportation booking, in accordance with some exemplary embodiments of the disclosed subject matter.

The vehicle management extension is a computerized device located in the farebox passenger transport vehicle (e.g. bus).

At 401, vehicle management extension 106 receives an event.

At 402, the source of the event is analyzed. Operations described with reference to blocks 403, 408, 409 and 415 are applicable if the source of the event is central management system 105.

At 403 the source of the event is determined as the central management system and the message type is analyzed.

At 408, the message type is determined as a passenger order.

At 409, the message type is determined as other message. At 415, the request is processed. Processing the request is explained in greater detail in FIG. 4a.

Operations described with reference to blocks 404, 410, 414 and 417 are applicable if the source of the event is the farebox (tickets machine).

At 404, the message type is determined as a message from the tickets machine. Such a message is received when a passenger purchases a ticket.

At 410, the message type is determined as a message regarding a new passenger. The message can include the fare.

At 414, the data base is updated.

At 417, the driver's command and control screen is updated and displays to the driver the current status on the bus, allowing the driver to control the number of passengers entering the bus.

Operations described with reference to blocks 405, 411, 414 and 417 are applicable if the source of the event is a sensor system.

At 405, the message type is determined as a message from the sensor system 502 (e.g. door sensor). Such a message is received, for example, when a passenger enters or leaves the passenger transport vehicle.

At 411, the message type is determined either as a message regarding a passenger leaving the bus or as a message regarding a passenger entering the bus.

At 414, the data base is updated and, in particular, the number of passengers in the bus is updated.

At 417, the driver command and control screen is updated and displays to the driver the current status on the bus, allowing the driver to control the number of passengers entering the bus. The information which is provided to the driver includes information indicative of currently occupied places (e.g. seats and standing places) as well as information regarding the reserved seats which may not all be currently occupied.

Operations described with reference to blocks 406, 412, 416 and 417 are performed if the source of the event is a seat sensor. The process is explained in greater detail in FIG. 4b.

At 406, the message type is determined as a message from the seat sensor (occupancy detector).

At 414, the data base is updated and, in particular, the number of free seats is updated.

At 417, the driver's command and control screen is updated, and displays to the driver the current status on the bus, allowing the driver to control the number of passengers that are allowed to enter the bus.

Operations described with reference to blocks 407 and 413 are applicable if the source of the event is the GPS system.

At 406, the message type is determined as a message from the GPS system.

At 413, the location of the bus is updated. In addition, an event of arrival or departure from a bus stop can be updated.

FIG. 4a shows an exemplary flowchart diagram of a method for processing a request for ordering a ticket, in accordance with some exemplary embodiments of the disclosed subject matter. The operation described with reference to FIG. 4a can be executed by vehicle management extension 106.

At 408, a passenger order is received.

At 418, the availability is checked with the bus local database 1062

As mentioned above the availability is determined based on a first occupancy data indicative of currently occupied places on the vehicle and a second occupancy data indicative of reserved places on the vehicle, some of which may be currently unoccupied. Based on the first and second occupancy data, vehicle management extension 106 can determine whether there are vacant places on the bus.

At 419, the availability of a sitting place is checked. Operations described with reference to blocks 424, 425,426,427 428, 429 and 430 are applicable if a seat or a standing place is available.

At 424, the passenger order is confirmed.

At 425, a report is sent to the central management system.

At 426, an electronic ticket is sent to the passenger.

At 427, a seat or a standing place is reserved.

At 428, a check is performed to check if the reservation is for a standing or for a seating place.

At 430, which is performed if the reservation is for a seating place, a reserved seat sign is turned on to indicate that the seat is reserved. In some cases the reserved seat sign is a LED.

At 429, the availability of the places in the bus is updated.

Optionally in case it is determined that no seat is available in the next bus (block 420), the passenger is queried as to whether he prefers a sitting place (in a different bus) or a standing place in the next bus (block 421).

At 423, if the passenger indicated that he prefers a seat in a different bus, the vehicle management extension sends the order back to the central management system.

FIG. 4b shows an exemplary flowchart diagram of a method for processing a request when a seat becomes empty, in accordance with some exemplary embodiments of the disclosed subject matter. A seat can become empty when a passenger leaves the bus at the required destination or when a passenger stands up for any other reason. Vehicle management extension can be therefore configured, responsive to receiving an indication that a seat has become vacant, to determine whether the passenger has reached his destination before it assigns the seat as vacant.

At 416, an event indicating that a passenger left his seat is received.

At 431, a check is done to find whether this seat is a reserved seat. If the seat is a reserved seat, a check is done to see if the passenger arrived to his destination (block 432). Information with respect to the destination is provided by the passenger when purchasing the ticket.

Operations described with reference to blocks 433,434 and 435 are performed if the passenger arrives at the destination.

At 433, the reserved seat sign goes off.

At 434 the availability in the data base is updated.

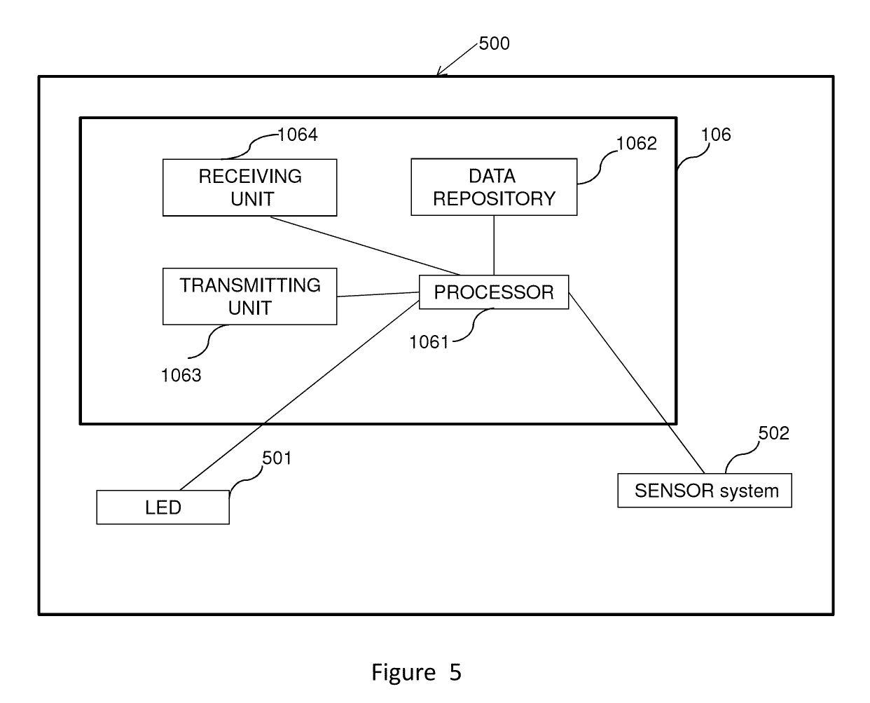

FIG. 5 shows an exemplary functional block diagram of a system that is installed in a passenger transport vehicle, in accordance with the presently disclosed subject matter.

System 500 includes vehicle management extension 106 located in the driver's cabinet farebox, LED 501 installed on or near the passenger seats to indicate if a certain seat is reserved or available, and sensors 502.

The vehicle management extension 106 includes a processor 1061, data repository 1062, a transmitting unit 1063 and a receiving unit 1064.

The receiving unit 1064 is configured for receiving messages from the bus management station (not shown). The messages include requests for booking a place in the bus for a specific user and messages acknowledging the request.

The processor 1061 is configured for processing the requests and for updating the data repository 1062. The processor 1061 is also configured for controlling the LED 501 and for receiving signals from the sensor 502 when a passenger leaves the bus. The processor 1061 is also configured for issuing responses that are sent by the transmitting unit 1063 to the central management system (not shown).

The LED 501 is configured to turn on and off according to the control of the processor. In some embodiments a LED that is turned on indicates a reserved seat.

Sensor 502 can be for example a door sensor configured for detecting an event of a passenger leaving the bus and for notifying the vehicle management extension 106 about the event. The sensor 502 may communicate with the vehicle management extension 106 via USB, Bluetooth or any other communication facility.

The transmitting unit 1063 is configured to transmit messages to the central management system (not shown). Such messages include a reply to the request of a passenger to book a place in the bus. The transmitting unit 1063 is also configured for transmitting a signal identifying the bus upon arriving to a bus stop. The transmitting unit 1063 includes communication drivers such as Wi-Fi driver, Bluetooth Driver and the like.

The data repository 1062 includes data related to occupied seats and standing places. The data repository may be updated whenever a passenger acknowledges a ticket order, whenever a passenger that booked a place boards the bus and whenever a passenger leaves the bus. Thus, the data-repository is constantly updated with information indicative of the pending orders and the currently available seats (and standing places) on the respective bus. Vehicle management extension 106 can be configured to update data repository 1062 whenever an order is received, thereby maintaining information indicative of the number of currently pending orders.

As mentioned above, keeping track of the current occupancy of the seats on the bus can be achieved by different methods. For example, each seat can be configured with a sensor which can sense whether a person is currently seated on the seat. This sensor can be any type of suitable sensor such as a light sensor or a weight sensor for sensing the weight exerted on the seat.

Alternatively or additionally, other sensor systems can be used for monitoring the number of passengers which are currently on the bus. This sensor can be for example, a door sensor, which can be for example a laser or infrared sensor system, configured to sense and count the number of passengers who are boarding and the number of passengers who are exiting through the doors. In addition or instead, one or more camera systems can be used for detecting and counting the number of passengers which are currently on the bus.

Information with respect to the current number of occupied seats and the overall number of passengers on the bus, obtained by the sensor systems, can be stored in data-repository 1062.

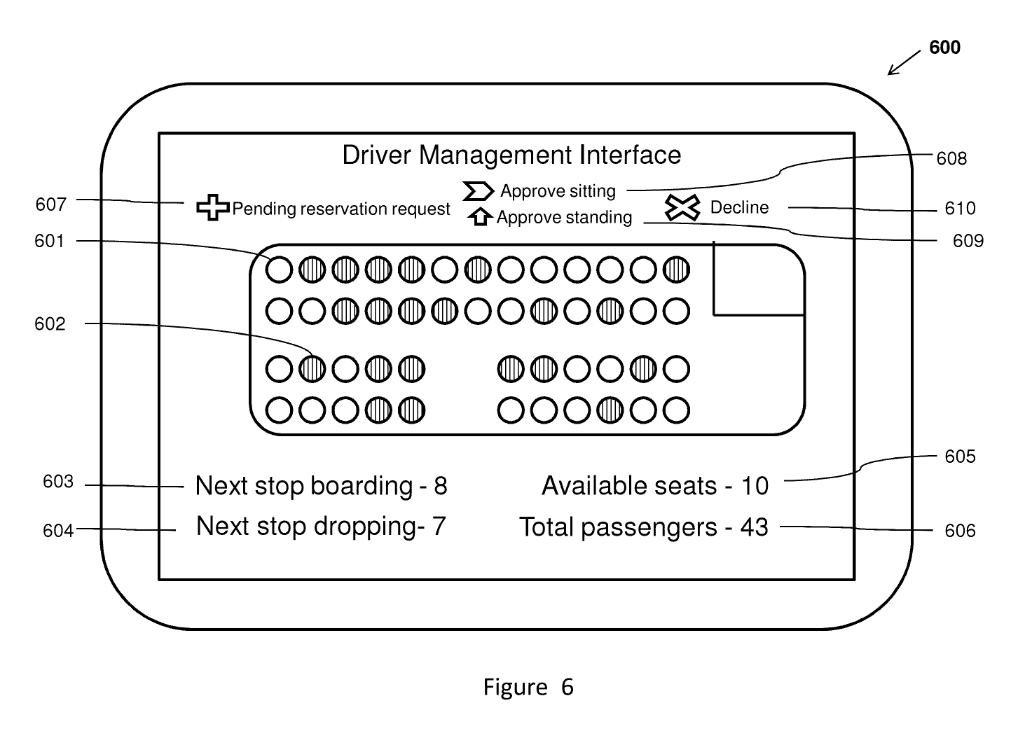

FIG. 6 shows an exemplary driver's command and control screen. The driver's command and control screen 600 may be based on a dedicated tablet. Alternatively the interface may be based on an application running over a Smartphone. Yet alternatively, the interface may be based on a device already being used by an existing management system.

The management interface 600, displays the bus including available seats 601 and occupied or reserved seats 602. Additional information such as the expected number of passengers to be boarding during the next station 603 and the number of passengers expected to be dropped off at the next station 604. Other information such as the available seats counter 605 and the total number of passengers 606 is presented. The driver may update the interface by clicking on seats which are made available or occupied. The interface 600 is also automatically updated according to reservations and cancellations which are performed online. The total number of passengers 606 icon may blink when the total number of passengers exceeds a predefined limit.

The management interface 600 may also present reservation requests from passengers and to approve or to decline the requests according to the current availability of seats or a standing place. For instance, a pending reservation request may be presented on the screen of the interface 607; alternatively the seats may blink to indicate a pending reservation request. The driver may approve a sitting place 608 or suggest a standing place 609 instead to be further confirmed by the passenger, unless the passenger originally requested a standing place, in such a case the driver may approve the passenger's request if a standing place is available 609. The driver may decline requests which may not be provided due to lack of availability 610.

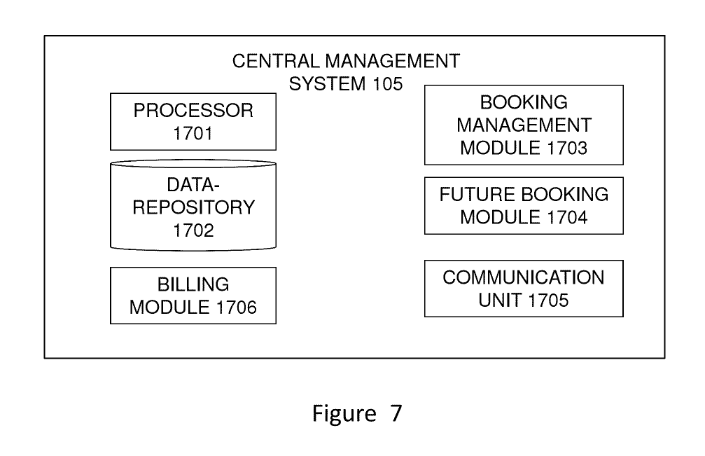

FIG. 7 is a functional block diagram of central management system, in accordance with the presently disclosed subject matter. Central management system comprises one or more processors 1701; data-repository 1702, an order management module 1703; future booking module 1703; and communication unit 1704. The different functions of the various units are specified in more detail with reference to FIG. 3 described above.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable non-transitory memory tangibly embodying a program of instructions executable by the machine for executing the disclosed method.

The operations in accordance with the teachings herein may be performed by a computer specially constructed for the desired purposes or by a general purpose computer specially configured for the desired purpose by a computer program stored in a non-transitory computer readable storage medium.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A system of ticket booking management of a passenger transport vehicle, the passenger transport vehicle comprising a plurality of places for accommodating passengers, the places can comprise at a given time a combination of booked places, which are previously booked by respective passengers, and non-booked places, which are available for passengers who board the vehicle without a pre-booked place; the system comprising:
a vehicle management extension of a respective passenger transport vehicle, comprising at least one processer operatively connected to a computer memory and configured to:
obtain information with respect to a request, of a respective passenger, to book a place on the vehicle; obtain a first occupancy data indicative of currently occupied places on the vehicle; obtain a second occupancy data indicative of currently booked places on the vehicle; determine, based on the first occupancy data and the second occupancy data whether a vacant place is available for the respective passenger; and book a place on the vehicle for the respective passenger in case it is determined that a vacant place is available.

2. The system according to claim 1 wherein the vehicle management extension further comprises a data-repository for storing at least the first and second occupancy data; the processor is further configured to continuously obtain information with respect to the first occupancy data and the second occupancy data and update the first and second occupancy data stored in the data-repository accordingly.

3. The system according to claim 1 wherein the vehicle management extension is operatively connected to one or more sensors located in the vehicle and configured to obtain the first occupancy data.

4. The system according to claim 1 wherein the vehicle management extension comprises a communication facility configured to enable communication with one or more client devices and obtain from the one or more client devices one or more requests to book places.

5. The system according to claim 1 wherein the request includes information indicating a respective destination; the processor is further configured, responsive to information indicative that a seat has become empty, to determine whether the respective passenger has reached a respective destination and in case the passenger has done so, to assign the seat as vacant and update the first and second occupancy data accordingly.

6. The system according to claim 1 wherein the places include seats and standing places in the vehicle; wherein the vacant place is a vacant seat and in case no vacant seat is available, the processor is further configured to send to a client device of the respective passenger a selection between a standing place in the next vehicle and a seat in a different vehicle.

7. The system according to claim 1 further comprising a computerized central management system being operatively connectible to a plurality of vehicle management extensions or respective vehicles; the central management system is configured to obtain from a client device the request; the request includes information indicative of a selected route, time and date; the central management system is configured to identify a corresponding vehicle which matches the information in the request and sends the request to the corresponding vehicle.

8. The system according to claim 7 wherein the central management system is further configured to obtain information with respect to real-time demands for one or more vehicles and respective routes, and adapt the allocation and scheduling of vehicles based on the real-time demand.

9. The system according to claim 1 wherein the request to book a place on the vehicle is an online booking, received while the vehicle is on its way on its scheduled route.

10. The system according to claim 1 wherein the request includes information indicative of a selected route, the rout comprising multiple stations; the information being further indicative of a boarding station, where the passenger is destined to board the vehicle and a disembark station, where the passenger is destined to leave the vehicle; wherein the boarding station and the disembark station may be any one of the multiple stations.

11. The system according to claim 1 wherein only part of the plurality of places on the vehicle is designated for booking and the other places are designated for passengers boarding the vehicle without booking.

12. The system according to claim 1, wherein the system is further operable to provide to a client device of the respective passenger, information indicating the current location of the vehicle.

13. The system according to claim 1 further comprising an indicator on each seat, indicating whether the seat is occupied.

14. The system according to claim 1 further comprising a driver's command and control configured to provide the driver with information with respect to the first occupancy data and the second occupancy data, enabling the driver to determine whether or not to allow boarding of one or more passengers on the vehicle.

15. The system according to claim 1 wherein the passenger transport vehicle is a bus.

16. A computerized method of ticket booking management of a passenger transport vehicle, the passenger transport vehicle comprising a plurality of places for accommodating passengers, the places can comprise at a given time a combination of booked places, which are previously booked by respective passengers and non-booked places, which are available for passengers who board the vehicle without a pre-booked place; the method comprising:
obtaining information with respect to a request, of a respective passenger, to book a place on the vehicle;
obtaining a first occupancy data indicative of currently occupied places on the vehicle;
obtaining a second occupancy data indicative of currently reserved places on the vehicle;
determining, based on the first occupancy data and the second occupancy data whether a vacant place is available for the respective passenger; and
booking a place on the vehicle for the respective passenger in case it is determined that a vacant place is available.

17. The method according to claim 16 further comprising:
obtaining information with respect to the first occupancy data and the second occupancy data and updating the first and second occupancy data stored in a designated data-repository.

18. The method according to claim 16 further comprising: obtaining from one or more sensors located in the vehicle the first occupancy data.

19. The method according to claim 16 further comprising: enabling communication with one or more client devices and obtaining from the one or more client devices one or more requests to book places.

20. The method according to claim 16 wherein the request includes information indicating a respective destination; responsive to information indicative that a seat has become empty, the method further comprises: determining whether the respective passenger has reached a respective destination and in case the passenger has done so, assigning the seat as vacant and updating the first and second occupancy data accordingly.

21. The method according to claim 16 wherein the places include seats and standing places in the vehicle; wherein the vacant place is a vacant seat, the method further comprising: in case no vacant seat is available, sending to a client device of the respective passenger a selection between a standing place in the next vehicle and a seat in a different vehicle.

22. The method according to claim 16, further comprising:
obtaining, from a client device, information with respect to the request; information indicative of a selected route, time and date; identifying a corresponding vehicle which matches the information in the request; and sending the request to the corresponding vehicle.

23. The method according to claim 24 further comprising: obtaining information with respect to real-time demands for one or more vehicles and respective routes; and adapting the allocation and scheduling of vehicles to the real-time demand.

24. The method according to claim 16 wherein the request to book a place on the vehicle is an online booking, the request being received while the vehicle is on its way on its scheduled route.

25. The method according to claim 16 wherein the request includes information indicative of a selected route, the rout comprising multiple stations; the information being further indicative of a boarding station, where the passenger is destined to board the vehicle and a disembark station, where the passenger is destined to leave the vehicle; wherein the boarding station and the disembark station may be any one of the multiple stations in the route.

26. The method according to claim 16, further comprising: providing to a client device of the respective passenger, an electronic ticket.

27. The method according to claim 16 further comprising: providing a driver of the vehicle with information with respect to the first occupancy data and the second occupancy data, to enable the driver to determine whether or not to allow boarding of one or more passengers on the vehicle.

28. The method according to claim 16 wherein only part of the plurality of places on the vehicle is designated for booking and the other places are designated for passengers boarding the vehicle without booking.

29. A program storage device readable by machine, tangibly embodying a program of instructions executable by the machine to perform a method of ticket booking management of a passenger transport vehicle, the passenger transport vehicle comprising a plurality of places for accommodating passengers, the places can comprise at a given time a combination of booked places, previously booked by respective passengers and non-booked places, which are available for passengers who board the vehicle without a previously booked place; the method comprising:
obtaining information with respect to a request, of a respective passenger, to book a place on the vehicle;
obtaining a first occupancy data indicative of currently occupied places on the vehicle;
obtaining a second occupancy data indicative of currently reserved places on the vehicle;
determining, based on the first occupancy data and the second occupancy data whether a vacant place is available for the respective passenger; and
booking a place on the vehicle for the respective passenger in case it is determined that a vacant place is available.
